(19) United States
(12) Patent Application Publication
(10) Pub. No.: US 2025/0054391 A1
(43) Pub. Date: Feb. 13, 2025

(54) DEFINING A PARKING AREA

(71) Applicant: Micron Technology, Inc., Boise, ID (US)

(72) Inventors: Poorna Kale, Folsom, CA (US); Febin Sunny, Folsom, CA (US)

(21) Appl. No.: 18/776,977

(22) Filed: Jul. 18, 2024

Related U.S. Application Data
(60) Provisional application No. 63/518,816, filed on Aug. 10, 2023.

(51) Int. Cl. G08G 1/14; G01C 21/36; G08G 1/16

(52) U.S. Cl. CPC G08G 1/146; G01C 21/3685; G08G 1/168

(57) ABSTRACT

Apparatuses and methods related to defining a parking area are described. In an example, an apparatus can include a memory and a processor coupled to the memory, wherein the processor is configured to receive vehicle data, receive sensor data of a parking lot, and define a parking area within the parking lot for a vehicle to park based on the received vehicle data and the received sensor data.

### PRIORITY INFORMATION

This application claims the benefit of U.S. Provisional Application No. 63/518,816, filed Aug. 10, 2023, the contents of which are included herein by reference.

### TECHNICAL FIELD

The present disclosure relates generally to defining a parking area.

### BACKGROUND

A vehicle can include one or more sensors. Operations can be performed based on data collected by the one or more sensors. For example, the vehicle can notify a driver of the vehicle that the vehicle is low on oil or gas.

A computing device can be a mobile device (e.g., a smart phone), a medical device, or a wearable device, for example. Computing devices can also include one or more sensors and perform operations based on data collected by the one or more sensors. For example, some computing devices can detect and store a location of the computing device.

### BRIEF DESCRIPTION OF THE DRAWINGS

FIG. 1 illustrates an example of a server in accordance with a number of embodiments of the present disclosure.

FIG. 2 illustrates an example of a computing device in accordance with a number of embodiments of the present disclosure.

FIG. 3 illustrates an example of a system including parking area management and a computing device in accordance with a number of embodiments of the present disclosure.

FIG. 4 is a diagram illustrating a parking lot in accordance with a number of embodiments of the present disclosure.

FIG. 5 is a block diagram of an example computer system in which embodiments of the present disclosure may operate.

### DETAILED DESCRIPTION

The present disclosure includes methods, apparatuses, and systems related to defining a parking area. An example apparatus includes a memory and a processor coupled to the memory, wherein the processor is configured to receive vehicle data, receive sensor data of a parking lot, and define a parking area within the parking lot for a vehicle to park based on the received vehicle data and the received sensor data.

Parking lots usually have a number of designated parking spots. These parking spots can be delineated by lines painted on the parking lot surface. Vehicles vary in size and one vehicle may take up more or less space than another vehicle. However, since the lines defining the spaces in the parking lot are fixed, the parking lot can only accommodate as many vehicles as there are parking spots.

Aspects of the present disclosure address the above and other deficiencies by defining a parking area based on the vehicle. Accordingly, parking lots can more efficiently use space by allocating a parking area that provides an amount of space for a particular vehicle. For example, a car can be given a smaller parking area than a truck. Providing an amount of space for a particular vehicle can also prevent damage to the particular vehicle and surrounding vehicles by ensuring spacing between vehicles is enough for a driver, passenger, and/or cargo to enter and exit the particular vehicle without contacting the surrounding vehicles.

As used herein, “a number of” something can refer to one or more of such things. For example, a number of sensors can refer to one or more sensors. A “plurality” of something intends two or more.

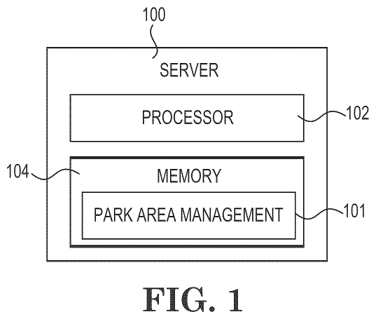

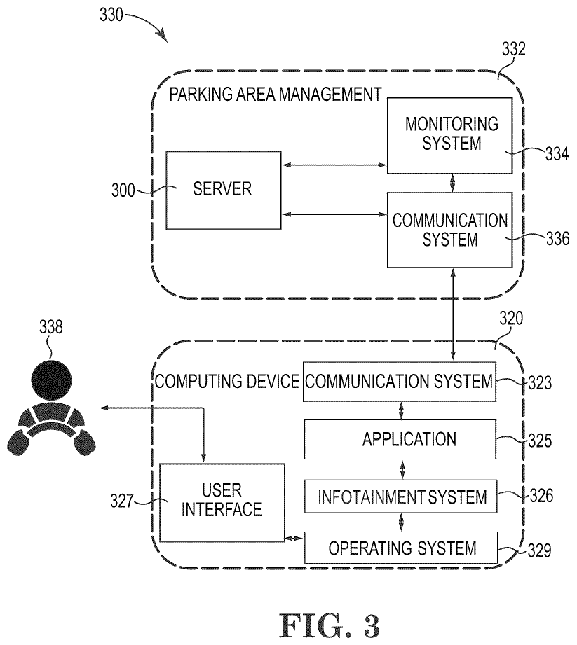

The figures herein follow a numbering convention in which the first digit or digits correspond to the drawing figure number and the remaining digits identify an element or component in the drawing. Similar elements or components between different figures may be identified by the use of similar digits. For example, reference numeral 100 may reference element “00” in FIG. 1, and a similar element may be referenced as 300 in FIG. 3. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

FIG. 1 illustrates an example of a server 100 in accordance with a number of embodiments of the present disclosure. The server 100, as illustrated in FIG. 1, can include a processor 102 and a memory 104.

The memory 104 can be volatile or nonvolatile memory. The memory 104 can also be removable (e.g., portable) memory, or non-removable (e.g., internal) memory. For example, the memory 104 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 104 is illustrated as being located within server 100, embodiments of the present disclosure are not so limited. For example, memory 104 can be located on an external apparatus (e.g., enabling computer readable instructions to be downloaded over the Internet or another wired or wireless connection).

Memory 104 can be any type of storage medium that can be accessed by the processor 102 to perform various examples of the present disclosure. For example, the memory 104 can be a non-transitory computer readable medium having computer readable instructions (e.g., computer program instructions) stored thereon including park area management 101 computer readable instructions that are executable by the processor 102 to receive vehicle data, receive sensor data of a parking lot, and define a parking area within the parking lot for a vehicle to park based on the received vehicle data and the received sensor data.

The received sensor data can be from various types of sensors. Some examples of sensors include a light detection and ranging (LIDAR) sensor and image sensors. The image sensors can be visible light cameras and/or infrared cameras. These sensors can be located throughout the parking lot to detect and transmit the location of vehicles and/or structures, including walls and building supports, throughout the parking lot to the processor 102. In a number of embodiments, locations of structures can be identified, mapped, and stored using sensor data collected when vehicles, people, and/or other non-permanent objects are absent from the parking lot to allow the processor 102 to assign a structure label to everything present in the parking lot. The structures can be remapped at particular times and/or when structures in the parking lot change, for example, when structures are added, removed, or moved. Remapping structures of the parking lot infrequently can reduce processing time and the amount of processing and memory resources needed to map the parking lot. In a number of embodiments, the processor 102 can remap vehicles, people, and/or other non-permanent objects at a particular frequency or in response to a vehicle, person, and/other non-permanent object moving.

The vehicle data can include a type, manufacturer, and/or model of the vehicle. The vehicle data can be received from the user, stored in memory, and/or detected by the LIDAR sensors and/or image sensors. In some examples, the processor 102 can determine an area of the vehicle based on the type, manufacturer, and/or model of the vehicle. For example, the processor 102 can lookup the area of the vehicle in an online database or a database stored on memory 104 using the type, manufacturer, and/or model of the vehicle. In a number of embodiments, the processor 102 can determine an area of the vehicle based on the sensor data. For example, the width, length, and/or height of the vehicle can be determined by the size and number of pixels the vehicle takes up in a number of images captured by a number of image sensors. The area of the vehicle, in some examples, can include doors of the vehicle fully opened to prevent damage to the vehicle, neighboring vehicles, and/or structures of the parking lot.

The processor 102 can use the sensor data to determine a number of free (e.g., unoccupied) areas within the parking lot. The processor 102 can then compare the number of free areas with the area of the vehicle. A number of free areas greater than the area of the vehicle can be determined. The processor 102 can select a defined parking area within one of the number of free areas greater than the area of the vehicle based on a number of factors including, but not limited to, distance to defined parking area, distance from defined parking area to parking lot exit, cost of the defined parking area, or user preferences. User preferences can include selecting a defined parking area near a parking lot exit or near a stairway, for example.

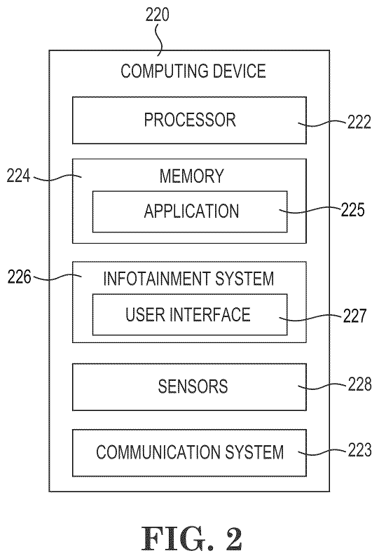

The processor 102 can transmit the defined parking area to an application on a computing device (e.g., computing device 220 in FIG. 2). The computing device can be the vehicle and/or a mobile device, for example. In some examples, a user can be presented with a number of defined parking areas and select a defined parking area of the number of parking areas. The defined parking area is not permanently defined as a parking space via lines painted on the parking lot surface, for example. Rather, the defined parking area is determined and conveyed to a user in a non-permanent manner. For example, a user of the computing device can be guided to the defined parking area by a number of lights. The lights can be a number of light-emitting diodes (LEDs) located in the parking lot that can turn on to guide the vehicle to the defined parking area in response to a command transmitted from the processor 102. In a number of embodiments, directions to the defined parking area can be transmitted to the computing device from the processor 102 and displayed on the computing device.

FIG. 2 illustrates an example of a computing device 220 in accordance with a number of embodiments of the present disclosure. The computing device 220 can be, but is not limited to, a vehicle, a wearable device, a medical device, and/or a mobile device. The vehicle can be, but is not limited to, a human operated vehicle, a self-driving vehicle, or a fully autonomous vehicle.

The computing device 220, as illustrated in FIG. 2, can include a processor 222, a memory 224, an infotainment system 226 including a user interface 227, a number of sensors 228, and a communication system 223. The memory 224 can be volatile or nonvolatile memory. The memory 224 can also be removable memory, or non-removable memory. For example, the memory 224 can be RAM, DRAM, PCRAM, ROM, EEPROM, flash memory, among other types of memory. Further, although memory 224 is illustrated as being located within computing device 220, embodiments of the present disclosure are not so limited. For example, memory 224 can be located on an external apparatus.

The memory 224 can be any type of storage medium that can be accessed by the processor 222 to perform various examples of the present disclosure. For example, the memory 224 can be a non-transitory computer readable medium having computer readable instructions stored thereon that are executable by the processor 222 to transmit vehicle data, receive data corresponding to a defined parking area for a vehicle to park within a parking lot, and display the data corresponding to the defined parking area on the user interface 227.

The user interface 227 can be generated by computing device 220 in response to one or more commands from the processor 222. The user interface 227 can be a GUI that can provide and/or receive information to and/or from the user of the computing device 220. In a number of embodiments, the user interface 227 can be an augmented reality (AR) display or a head-up-display (HUD) of the computing device 220.

In some examples, the user interface 227 can be included in an infotainment system 226 of the computing device 220. The infotainment system 226 can be Apple CarPlay or Android Auto, for example. The processor 222 can install an application 225 for parking in the parking lot on the infotainment system 226 and store the application 225 in memory 224. For example, a user can search and select to download the application 225 on the infotainment system 226 via the user interface 227.

Once the application 225 is downloaded, the user can enter or select the vehicle data within the application 225. The application 225 can receive a type, year, manufacturer, and/or model of the vehicle as the vehicle data. The vehicle data can be transmitted via the application 225 to, for example, a server (e.g., server 100 in FIG. 1). The data corresponding to the defined parking area for the vehicle to park within the parking lot can be received via the application 225 and can be displayed on the user interface 227 via the application 225. In a number of embodiments, the data corresponding to the defined parking area can include directions to the defined parking area. For example, the user interface 227 can provide turn-by-turn directions visually or audibly and/or provide directions and/or an outline of the defined parking area on a map of the parking lot, an AR display, and/or a HUD.

In a number of embodiments, the number of sensors 228 can be LIDAR sensors and/or image sensors. Sensor data from the number of sensors 228 of the computing device 220 can be transmitted to the server via the application 225. In some examples, the server can define the parking area, guide the user to the defined parking area, and/or determine vehicle data based on the sensor data from the number of sensors 228 of the computing device 220.

The computing device 220 can transmit sensor data and/or vehicle data via communication system 223. The communication system 223 can include a transceiver for communicating with the server and/or a transceiver for communicating with another device (e.g., a cell phone) that communicates with the server. In a number of embodiments, the communication system 223 can be used to receive data corresponding to the defined parking area.

FIG. 3 illustrates an example of a system 330 including parking area management 332 and a computing device 320 in accordance with a number of embodiments of the present disclosure. The parking area management 332 can include a server 300 (e.g., server 100 in FIG. 1), a monitoring system 334, and a communication system 336.

The communication system 336 can include or be a part of a wide area network (WAN) and a local area network (LAN). For example, a LAN can include the server 300, the monitoring system 334, and/or the computing device 320. The LAN can be a secure (e.g., restricted) network for communication between the server 300, the monitoring system 334, and/or the computing device 320. The LAN can include a personal area network (PAN), for example Bluetooth or Wi-Fi Direct. In some examples, a number of computing devices within or within a particular distance of the communication system 336 can transmit and/or receive data via the LAN. Vehicle data from the computing device 320 can be solely shared within the LAN to protect vehicle data from theft. For example, vehicle data from computing device 320 will not be used and/or transmitted outside of the LAN unless permitted by the user of the computing device 320.

A WAN can further include a cloud computing system and/or a different computing device. The WAN can be a distributed computing environment, the Internet, for example, and can include a number of servers that receive information from and transmit information to the server 300, the monitoring system 334, and/or the computing device 320. Memory and processing resources can be included in the communication system 336 to perform operations on data. The communication system 336 can receive and transmit information to the server 300, the monitoring system 334, and/or the computing device 320 using the LAN and/or WAN. For example, the computing device 320 can transmit vehicle data to the server 300, the monitoring system 334 can transmit sensor data to the server 300, and the server 300 can transmit data corresponding to a defined parking area to the computing device 320.

The monitoring system 334 can include a number of sensors located throughout a parking lot. The sensors can include LIDAR sensors and/or image sensors. The sensors can monitor usage of the parking lot and transmit sensor data to the server 300. Specifically, sensors can identify free areas, void of vehicles and structures, that can be used as a number of defined parking areas. Over time vehicles enter and exit the parking lot changing the number of, the location of, and/or the area of the free areas. The free areas can be identified by the server 300 based on the sensor data in response to detecting movement in the parking lot and/or in response to a particular amount of time passing. For example, the server 300 can compare LIDAR data to previous LIDAR data in the same location and movement in the parking lot can be detected in response to the LIDAR data being different from the previous LIDAR data. Free areas can then be identified again in response to detecting movement.

The computing device 320 can include a communication system 323, an application 325, an infotainment system 326, and a user interface 327, as previously described in connection with FIG. 2. The computing device 320 can further include an operating system 329. The operating system 329 can manage hardware and software for computing device 320. The application 325 installed on the infotainment system 326 can be displayed to a user 338 on the user interface 327 via the operating system 329. Although a single computing device 320 is illustrated in FIG. 3, the parking area management 330 can be in communication with a number of computing devices, analogous to computing device 320.

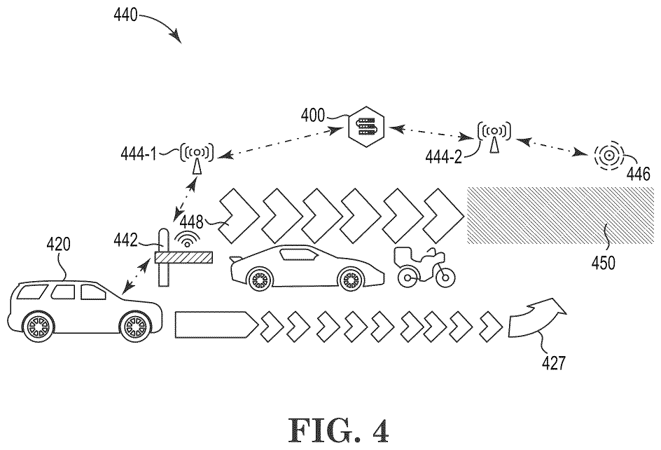

FIG. 4 is a diagram illustrating a parking lot 440 in accordance with a number of embodiments of the present disclosure. The parking lot 440 can be any area accommodating vehicles including a parking structure, off-street parking, and/or on street parking. The parking lot 440 can include an access 442, a number of antennas 444-1, . . . , 444-2, a server 400, a number of sensors 446, and/or a number of lights 448.

In some examples, the access 442 can be a computing device coupled to a gate to allow or prevent entry to the parking lot 440. The access 442 can include a payment option and/or a user interface to enter vehicle data and/or define a parking area.

The number of antennas 444-1, . . . , 444-2 can be located throughout the parking lot 440. The number of antennas 444-1, . . . , 444-2 can be included in a communication system (e.g., communication system 336 in FIG. 3) to allow the communication between computing devices, for example, vehicle 420, the number of sensors 446, and/or the server 400.

The number of sensors 446 can include LIDAR sensors and/or image sensors. The number of sensors 446 can monitor usage of the parking lot 440 and transmit sensor data to the server 400 via the number of antennas 444-1, . . . , 444-2. Monitoring usage can include identifying free areas, void of vehicles and structures, that can be used as a number of defined parking areas. Over time vehicles enter and exit the parking lot changing the number of, the location of, and/or the area of the free areas. The free areas can be identified based on the sensor data in response to detecting movement in the parking lot and/or in response to a particular amount of time passing.

The server 400 can receive the sensor data and use the sensor data to determine free and/or occupied area within the parking lot 440. The server 400 can also receive vehicle data, for example, a selection of a year, type, manufacturer, and/or model of vehicle 420 when the user is at the access 442. The server 400 can determine an area of the vehicle 420 by looking up the vehicle in an online database or a database stored on the server 400 using the year, type, manufacturer, and/or model of the vehicle 420. For example, the sever 400 can receive a 2014 Buick Regal as the vehicle data and lookup the 2014 Buick Regal in a database to find an area of the 2014 Buick Regal.

The server 400 can compare the area of the vehicle 420 to the free area within the parking lot 440 and define a parking area 450 within the free area within the parking lot 440 based on the comparison. In a number of embodiments, the server 400 can charge a fee based on the type of the vehicle 420, the size of the vehicle 420, the portion of the vehicle 420 outside the defined parking area 450, or the period of time the vehicle 420 is parked. The type of vehicle 420, size of the vehicle 420, the portion of the vehicle 420 outside the defined parking area 450, and/or the period of time the vehicle 420 is within the parking lot 440 can be determined based on additional sensor data from the sensors 446.

The number of lights 448 within the parking lot 440 can receive a command from the server 400 to turn on. The number of lights 448 can be LED strips on the floor, signs, and/or walls of the parking lot 440. The number of lights 448 can guide the vehicle 420 to a defined parking area 450 and/or indicate the defined parking area 450. In some examples, the number of lights 448 may turn on when the vehicle 420 does not have AR capabilities. If the vehicle does have AR capabilities, a user interface (e.g., user interface 227 in FIG. 2) of the vehicle 420 can display AR guides 427 to the defined parking area 450.

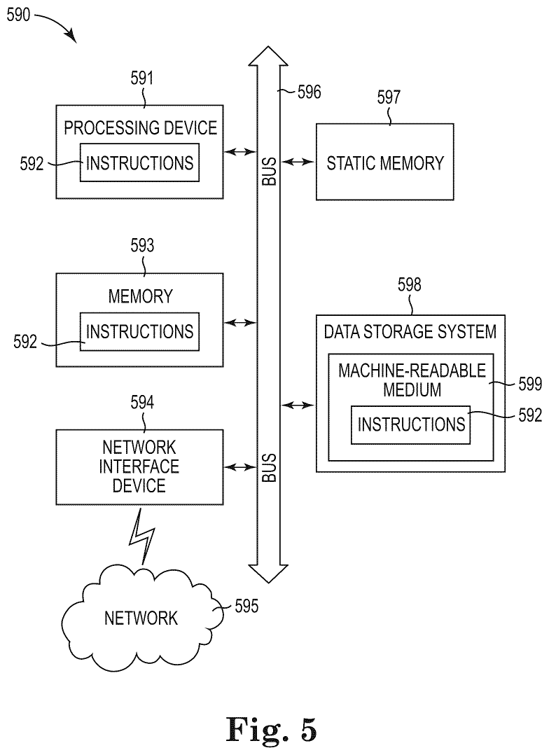

FIG. 5 is a block diagram of an example computer system 590 in which embodiments of the present disclosure may operate. For example, FIG. 5 illustrates an example machine of a computer system 590 within which a set of instructions, for causing the machine to perform any one or more of the methodologies discussed herein, can be executed. In some embodiments, the computer system 590 can correspond to a host system that includes, is coupled to, or utilizes a memory sub-system. The computer system 590 can be used to perform the operations described herein (e.g., to perform operations corresponding to the processor 102 of FIG. 1). In alternative embodiments, the machine can be connected (e.g., networked) to other machines in a LAN, an intranet, an extranet, the Internet, and/or wireless network. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 590 includes a processing device (e.g., processor) 591, a main memory 593 (e.g., read-only memory (ROM), flash memory, dynamic random access memory (DRAM) such as synchronous DRAM (SDRAM) or Rambus DRAM (RDRAM), etc.), a static memory 597 (e.g., flash memory, static random access memory (SRAM), etc.), and a data storage system 598, which communicate with each other via a bus 596.

The processing device 591 represents one or more general-purpose processing devices such as a microprocessor, a central processing unit, or the like. More particularly, the processing device 591 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 591 can also be one or more special-purpose processing devices such as an application specific integrated circuit (ASIC), a field programmable gate array (FPGA), a digital signal processor (DSP), network processor, or the like. The processing device 591 is configured to execute instructions 592 for performing the operations and steps discussed herein. The computer system 590 can further include a network interface device 594 to communicate over the network 595.

The data storage system 598 can include a machine-readable storage medium 599 (also known as a computer-readable medium) on which is stored one or more sets of instructions 592 or software embodying any one or more of the methodologies or functions described herein. The instructions 592 can also reside, completely or at least partially, within the main memory 593 and/or within the processing device 591 during execution thereof by the computer system 590, the main memory 593 and the processing device 591 also constituting machine-readable storage media. The machine-readable storage medium 599, data storage system 598, and/or main memory 593 can correspond to the memory 104 of FIG. 1.

In one embodiment, the instructions 592 include instructions to implement functionality corresponding to defining a parking area (e.g., using processor 102 of FIG. 1). While the machine-readable storage medium 599 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus comprising:
a memory; and
a processor coupled to the memory, wherein the processor is configured to:
receive vehicle data;
receive sensor data of a parking lot; and
define a parking area within the parking lot for a vehicle to park based on the received vehicle data and the received sensor data.

2. The apparatus of claim 1, wherein the vehicle data includes a year, type, manufacturer, and/or model of the vehicle.

3. The apparatus of claim 1, wherein the processor is configured to determine an area of the vehicle based on the vehicle data.

4. The apparatus of claim 1, wherein the received sensor data is from light detection and ranging (LIDAR) sensors and/or image sensors.

5. The apparatus of claim 1, wherein the processor is configured to transmit the defined parking area to an application on the vehicle and/or a mobile device; and
wherein the defined parking area is not defined as a parking space in the parking lot prior to the processor defining the parking area.

6. The apparatus of claim 1, wherein the processor is configured to transmit directions to the defined parking area to an application on the vehicle and/or a mobile device.

7. The apparatus of claim 1, wherein the processor is configured to transmit a command to turn on a number of light-emitting diodes (LEDs) in the parking lot to guide the vehicle to the defined parking area.

8. An apparatus comprising:
a user interface;
a memory; and
a processor coupled to the memory and the user interface, wherein the processor is configured to:
transmit vehicle data;
receive data corresponding to a defined parking area for a vehicle to park within a parking lot; and
display the data corresponding to the defined parking area on the user interface.

9. The apparatus of claim 8, wherein the user interface is an augmented reality (AR) display or a head-up-display (HUD).

10. The apparatus of claim 8, wherein the processor is configured to:
install an application;
transmit the vehicle data via the application;
receive the data corresponding to the defined parking area for the vehicle to park within the parking lot via the application; and
display the data corresponding to the defined parking area on the user interface via the application.

11. The apparatus of claim 10, further comprising an infotainment system including the user interface, wherein the application is installed on the infotainment system.

12. The apparatus of claim 8, wherein the data corresponding to the defined parking area includes directions to the defined parking area.

13. The apparatus of claim 8, wherein the apparatus is a vehicle or a mobile device.

14. The apparatus of claim 8, wherein the processor is configured to:
receive a year, type, manufacturer, and/or model of the vehicle; and
transmit the year, type, manufacturer, and/or model of the vehicle as the vehicle data.

15. A method comprising:
receiving a selection of a type of vehicle;
determining an area of a vehicle based on the type of vehicle;
receiving sensor data from light detection and ranging (LIDAR) sensors in a parking lot;
determining free area within the parking lot;
comparing the area of the vehicle to the free area within the parking lot; and
defining a parking area within the free area within the parking lot based on the comparison.

16. The method of claim 15, further comprising charging a fee based on the type of vehicle.

17. The method of claim 15, further comprising:
determining a period of time the vehicle is within the parking lot based on additional sensor data from the LIDAR sensors; and
charging a fee based on the period of time.

18. The method of claim 15, further comprising turning on a number of lights within the parking lot to indicate the defined parking area.

19. The method of claim 15, further comprising displaying augmented reality (AR) guides to the defined parking area on a user interface of the vehicle.

20. The method of claim 15, further comprising:
determining whether a portion the vehicle is outside of the defined parking area based on additional sensor data from the LIDAR sensors; and
charging a fee based on the portion of the vehicle outside of the defined parking area.
